(19) United States
(12) Patent Application Publication
(10) Pub. No.: US 2011/0302643 A1
(43) Pub. Date: Dec. 8, 2011

(54) MECHANISM FOR AUTHENTICATION AND AUTHORIZATION FOR NETWORK AND SERVICE ACCESS

(75) Inventors: Roman Pichna, Espoo (FI); Sandro Grech, Bath (GB)

(73) Assignee: NOKIA SIEMENS NETWORKS OY, Espoo (FI)

(21) Appl. No.: 13/202,116

(22) PCT Filed: Mar. 31, 2009
(86) PCT No.: PCT/EP2009/053817

§ 371 Date: Aug. 18, 2011

(51) Int. Cl. H04W 12/06; G06F 15/16; G06F 21/20; H04W 12/08

(52) U.S. Cl. 726/7

(57) ABSTRACT

There is proposed a network access authentication and authorization mechanism in which an authentication session in an authentication, authorization and accounting procedure for a user equipment for providing an initial network access is executed. A first identification element related to the user equipment is obtained. Then, a user credential validation procedure is performed wherein a second identification element related to the user equipment or related to a user of the user equipment is obtained. The obtained first and second identification elements are processed for determining whether a match between the first and second identification elements exists. In addition, the authentication session executed for the user equipment is identified on the basis of the result of the processing of the first and second identification elements. Then, a change of an authorization of the user equipment is executed for providing a modified network access.

### BACKGROUND OF THE INVENTION

1. Field of the Invention

The present invention relates to network access authentication and authorization for gaining access to network and service resources in a communication network. In particular, the present invention relates to a mechanism usable for a network access authentication and authorization in a wireless network environment, such as WiMAX, by using a combination of two authentication methods based, for example, on the Extensible Authentication Protocol (EAP) and http authentication.

2. Related Prior Art

In the last years, an increasing extension of communication networks, e.g. of wire based communication networks, such as the Integrated Services Digital Network (ISDN), or wireless communication networks, such as the cdma2000 (code division multiple access) system, cellular 3rd generation (3G) communication networks like the Universal Mobile Telecommunications System (UMTS), cellular 2nd generation (2G) communication networks like the Global System for Mobile communications (GSM), the General Packet Radio System (GPRS), the Enhanced Data Rates for Global Evolutions (EDGE), or other wireless communication system, such as the Wireless Local Area Network (WLAN) or Worldwide Interoperability for Microwave Access (WiMAX), took place all over the world. Various organizations, such as the 3^{rd} Generation Partnership Project (3GPP), Telecoms & Internet converged Services & Protocols for Advanced Networks (TISPAN), the International Telecommunication Union (ITU), 3^{rd} Generation Partnership Project 2 (3GPP2), Internet Engineering Task Force (IETF), the IEEE (Institute of Electrical and Electronics Engineers), the WiMAX Forum and the like are working on standards for telecommunication network and access environments.

In order to gain access to a communication network and corresponding service resources, it is necessary that a subscriber performs an authentication and authorization procedure, which forms part of Authentication-Authorization-Accounting (AAA) framework.

Authentication refers to the confirmation that the subscriber who is requesting services is a valid user of the network services requested. For this purpose, an identity and credentials are used. Authorization describes the grant of services to the requesting subscriber on the basis of the service request and the authentication result. Accounting, on the other hand, is related to the tracking of the consumption of resources and is used for management, billing and the like.

There have been proposed a plurality of authentication mechanisms usable in the AAA procedure. One example is the so-called Extensible Authentication Protocol (EAP). EAP is a universal authentication framework defined by the IETF and provides several functions and a negotiation of the desired authentication mechanism. Such mechanisms are called EAP methods, for example EAP-TLS (EAP-Transport Layer Security), EAP-TTLS (EAP-Tunneled Transport Layer Security), EAP-AKA (EAP Authentication and Key Agreement), EAP-IKEv2 (EAP Internet Key Exchange Protocol version 2), a number of vendor specific methods and the like.

The WiMAX Forum Network Working Group (NWG) standard includes, for example, the following three basic authentication frameworks: device authentication with EAP-TLS, user authentication with EAP-TTLS (or EAP-AKA), and device and user authentication with EAP-TTLS. All of these authentication schemes require provisioned credentials in the mobile station (MS), or user interaction in case of user-authentication. For example, for the device authentication, X.509 device certificates may be required which may be installed by the device manufacturer (X.509 is a ITU-T standard for a public key infrastructure and used for digital certificates). Furthermore, for user authentication, user credentials depending on the EAP method are required, for example in case of EAP-TTLS\MS-CHAP-v2 (Microsoft® challenge-handshake authentication protocol), a username and a password are required. These can be provisioned in the subscriber's end user device, or supplied by the end-user in an interactive manner.

The EAP-TTLS\MS-CHAP-v2 method is one example of a frequently deployed user authentication scheme, for example in WiMAX network architectures. There are also other authentication schemes, such as EAP-AKA, which rely on different mechanisms, like a USIM (Universal Subscriber Identity Module) in the terminal, which are also supported by the WiMAX standards. It is to be noted that a fixed WiMAX network based on IEEE 802.16d, for example, may rely on certificate based device authentication via PKMv1 (PKM: Private Key Management). Mobile WiMAX networks, on the other hand, rely on EAP authentication via PKMv2 over radio link.

Presently, the WiMAX NWG standards support different frameworks for device provisioning, which are based, for example on Open Mobile Alliance Device Management (OMA-DM, which is a device management protocol specified by the Open Mobile Alliance) and TR-069 (which defines an application layer protocol for remote management of end-user devices). Amongst other things, these frameworks enable provisioning of the subscriber credentials during the first network entry.

However, these frameworks require further equipment in the network and increase thus the costs and complexity which may not always be feasible (technically and/or economically). Furthermore, compatibility of user terminals and corresponding support is necessary. Thus, deployment of such device provisioning functionality using e.g. OMA DM or TR-069 is often not effected by operators.

However, as an alternative usable for such operators not deploying OMA-DM or TR-069 solutions for provisioning user credentials in the MS, configuration of user credentials has to be done by the subscriber himself/herself, which depends on the subscriber's ability to configure his/her credentials manually. In some types of terminals (like mobile phones, integrated PC modules and the like) such configuration is rather straightforward due to the availability of configuration clients that can directly provision the EAP client running on the same host. In other device form factors, however, particularly in the case of CPE (Customer Premises Equipment) the same configuration is not as straightforward as the EAP client is running on a separate host (on board of the CPE) compared to the end-user terminal equipment (e.g. PC or laptop). CPE configuration involves steps that may not be within the capability of all potential customers. This may lead to a loss of potential customers for operators and/or more customer support overhead.

One solution of this problem may be to integrate browser-based authentication within WiMAX ASN (Access Service Network) and to bypass EAP authentication. However, this approach suffers from following drawbacks. First, there can not be provided any standardized solution for cryptographically protecting the Mobile WiMAX radio link, which includes message authentication for MAC management messages, and user plane protection. Therefore, network security is not ensured. Second, a web portal for browser authentication is open to any device/subscriber without prior authentication. Any other security holes in the system are also exposed to any device/subscriber without any prior authentication, thus there is no traceability/audit capability.

### SUMMARY OF THE INVENTION

Thus, it is an object of the invention to provide an improved mechanism for performing authentication/authorization of a user equipment (a subscriber) in a communication network for gaining access to network and service resources, wherein no complex and cost intensive infrastructure and support are necessary while the network security is maintained.

These objects are achieved by the measures defined in the attached claims.

In particular, according to one example of the proposed solution, there is provided, for example, a method comprising executing an authentication session in an authentication, authorization and accounting procedure for a user equipment for providing an initial network access, obtaining a first identification element related to the user equipment, performing a user credential validation procedure, obtaining, in the user credential validation procedure, a second identification element related to the user equipment or related to a user of the user equipment, processing the first and second identification elements for determining whether a match between the first and second identification elements exists, identifying the authentication session executed for the user equipment on the basis of the result of the processing of the first and second identification elements, and initializing a change of an authorization of the user equipment for providing a modified network access.

Furthermore, according to one example of the proposed solution, there is provided, for example, an apparatus comprising an authentication processor configured to execute an authentication session in an authentication, authorization and accounting procedure for a user equipment for providing an initial network access, a first processor portion configured to obtain a first identification element related to the user equipment, an validation processor configured to perform a user credential validation procedure, a second processor portion configured to obtain, in the user credential validation procedure, a second identification element related to the user equipment or related to a user of the user equipment, an information processor configured to process the first and second identification elements for determining whether a match between the first and second identification elements exists, a third processor portion configured to identify the authentication session executed for the user equipment on the basis of the result of the information processor processing of the first and second identification elements, and an initiator configured to initialize a change of an authorization of the user equipment for providing a modified network access.

According to further refinements, the above examples comprise one or more of the following:
when the initial network access is accepted, rule information for a restricted network access as the initial network access may be transmitted, wherein the rule information may comprise an address indication of a captive portal accessible by the restricted network access;
an identifier of an authentication, authorization and accounting client serving the user equipment in the authentication session for providing the initial network access may be stored, wherein said identifier may be bound to the first identification element, wherein the initialization of the change of the authorization may further comprise determining the authentication, authorization and accounting client serving the user equipment on the basis of the binding of the identifier to the first identification element by using the result of the processing of the first and second identification elements, and transmitting an authorization change instructing message to the determined authentication, authorization and accounting client;
for obtaining the first identification element, a unique address, in particular a media access control address, of the user equipment in the authentication session may be received; alternatively, for obtaining the first identification element, a settable address, in particular an Internet Protocol address, may be allocated to the user equipment, or a settable address, in particular an Internet Protocol address, allocated to the user equipment from an access service network element communicating with the user equipment may be received;
for obtaining the second identification element, a username indication of the user equipment as the second identification element may be received, wherein the processing of the first and second identification elements for determining whether a match between the first and second identification elements exists may comprise a mapping of the username indication to a pre-stored subscriber profile list indicating a relation between a respective username and a corresponding unique address, in particular a media access control address, of a user equipment, and a comparison of the unique address retrieved from the subscriber profile list and the received unique address for determining existence of the match between the first and second identification elements;
alternatively, for obtaining the second identification element, a unique address of the user equipment, in particular a media access control address, may be received as the second identification element in the user credential validation procedure, wherein the processing of the first and second identification elements for determining whether a match between the first and second identification elements exists may comprise a comparison of the unique address received in the user credential validation procedure and the unique address received in the authentication session for determining existence of the match between the first and second identification elements;
for obtaining the second identification element, a settable address of the user equipment, in particular an Internet Protocol address, may be received as the second identification element in the user credential validation procedure, wherein the processing of the first and second identification elements for determining whether a match between the first and second identification elements exists may comprise a comparison of the settable address received in the user credential validation procedure and the settable address allocated to the user equipment as the first identification element for determining existence of the match between the first and second identification elements;
the above measures may be implemented as a method or apparatus in an authentication, authorization and accounting server in a WiMAX based communication network.

Furthermore, according to one example of the proposed solution, there is provided, for example, a method comprising executing an authentication session in an authentication, authorization and accounting procedure for a user equipment for providing an initial network access, re-directing a request message from the user equipment to a predetermined address of an captive portal, and inserting a unique address, in particular a media access control address, of the user equipment into the redirected request message, said inserted unique address being provided as an identification element of the user equipment.

Furthermore, according to one example of the proposed solution, there is provided, for example, an apparatus comprising an authentication processor configured to execute an authentication session in an authentication, authorization and accounting procedure for a user equipment for providing an initial network access, a forwarder configured to re-direct a request message from the user equipment to a predetermined address of an captive portal, and an inserter configured to insert a unique address, in particular a media access control address, of the user equipment into the redirected request message, said inserted unique address being provided as an identification element of the user equipment.

The above measures may be implemented as a method or apparatus in one of an access service network element comprising an authentication, authorization and accounting client and a mobile Internet Protocol home agent in a WiMAX based communication network.

By virtue of the proposed solutions, it is possible to provide an easy and secure authentication/authorization procedure without involving high costs or support work. In particular, the proposed solution avoids the need for manual configuration outside the end-user's terminal equipment, while at the same time a deployment of costly centralized device provisioning systems is not necessary. Hence, the proposed solution does not rely, for example, on remote device provisioning or manual provisioning of the subscriber credentials of a subscriber's CPE. Instead, subscriber credentials may be supplied in an easy way, e.g. by input of information in a web browser template, which is a procedure being familiar to a huge amount of users. Thus, it is possible to obtain the following benefits: from an end-user perspective a user friendly access is provided which increases the acceptability, while from the operator perspective the user-friendly access can be provided without the need for complex and expensive solutions.

Moreover, it is possible to provide a cryptographic protection of the radio link by means of the keying material obtained in the processing, such as in the initial network access procedure. For this cryptographic protection, standardized procedures as defined, for example, in WiMAX may be used so that no customization of the end-user device is necessary for this to be possible.

In addition, network security can be ensured since by using the proposed solution an access to the network resources, such as a web-portal used for inputting identification of the user, is limited to devices that have passed a (first) authentication phase. Thus, any attempted abuse of the system (e.g. denial of service attacks or the like) is limited and traceable.

The above and still further objects, features and advantages of the invention will become more apparent upon referring to the description and the accompanying drawings.

### BRIEF DESCRIPTION OF THE DRAWINGS

FIG. 1 shows a system diagram illustrating elements of a simplified network architecture involved in a network access authentication and authorization according to an example of an embodiment of the invention.

FIG. 2 shows a signaling diagram of a first example of an embodiment of a network access authentication and authorization procedure.

FIG. 3 shows a signaling diagram of a second example of an embodiment of a network access authentication and authorization procedure.

FIG. 4 shows a signaling diagram of a third example of an embodiment of a network access authentication and authorization procedure.

FIG. 5 shows a signaling diagram of a fourth example of an embodiment of a network access authentication and authorization procedure.

FIG. 6 shows a flow chart illustrating a procedure executed for a network access authentication and authorization procedure according to examples of embodiments of the invention.

FIG. 7 shows a block circuit diagram illustrating elements of a network element involved in a network access authentication and authorization procedure according to examples of embodiments of the invention.

FIG. 8 shows a block circuit diagram illustrating elements of a further network element involved in a network access authentication and authorization procedure according to examples of embodiments of the invention.

### DESCRIPTION OF PREFERRED EMBODIMENTS

In the following, examples and embodiments of the present invention are described with reference to the drawings. For illustrating the present invention, the examples are based on a WiMAX system according to IEEE standards. However, it is to be noted that examples of embodiments of the invention are not limited to an application in such a system or environment but are also applicable in other network systems, connection types and the like, for example in networks according to 3GPP specifications, in Wireless Local Area Networks (WLAN) or the like.

A basic system architecture of a communication network may comprise a commonly known architecture of a wired or wireless access network subsystem. Such an architecture comprises one or more access network control units, radio access network elements or base transceiver stations, with which a user equipment or terminal device as a subscriber's communication unit is capable of communicating via one or more channels for transmitting several types of data. The general functions and interconnections of these elements are known to those skilled in the art and described in corresponding specifications so that a detailed description thereof is omitted herein. However, it is to be noted that there are provided several additional (not shown) network elements and signaling links used for a communication connection or a call between end terminals and/or servers.

Furthermore, the network elements and their functions described herein may be implemented by software, e.g. by a computer program product for a computer, or by hardware. In any case, for executing their respective functions, correspondingly used devices, such as a server or network element, like an Authentication-Authorization-Accounting (AAA) server or an Access Service Network (ASN) element (like a ASN Gateway (GW)), comprises several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, a network access and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

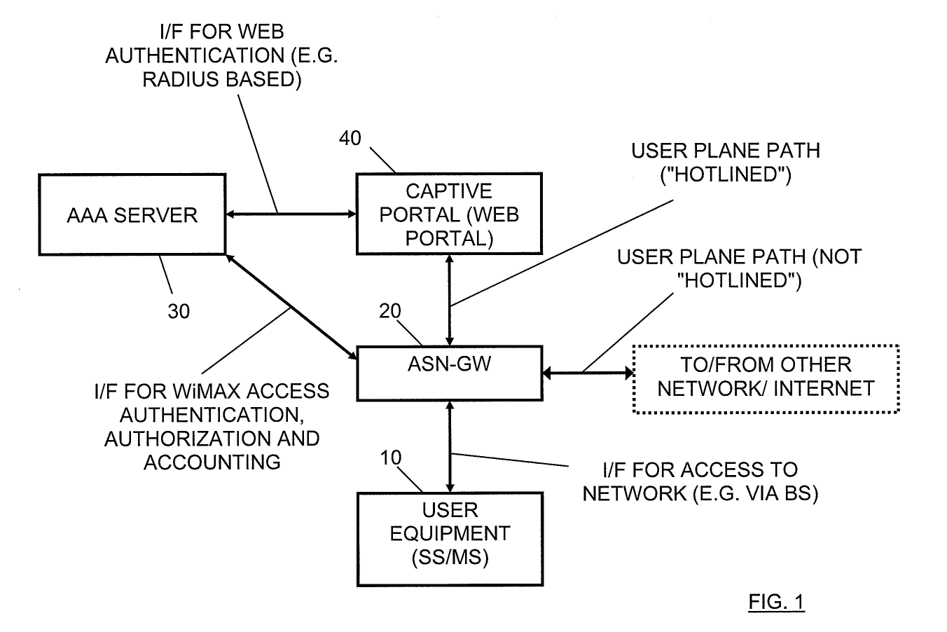

FIG. 1 shows a simplified diagram of an architecture of a communication network to which the present invention is applicable. In FIG. 1, an example based on WiMAX specification is presented. However, it is to be noted that also other network systems can use the principles defined below, for example a 3GPP based network, a WLAN and the like, or network systems developed in the future and having similar basic functionalities. Also, the architecture could be heterogeneous in the sense that the home network components are e.g. based on WiMAX specifications while a visited network is based on WLAN specifications. The respective network elements comprised by such network systems and in particular those being involved in the authentication and authorization procedure are generally known by those skilled in the art so that a detailed description thereof is omitted herein for the sake of simplicity. Furthermore, it is to be noted that the functional architecture can be designed into various hardware configurations rather than fixed configurations.

In the network system according to FIG. 1, network elements which are useful for understanding the principles of the present invention are shown. However, it is to be noted that there are of course several other elements not shown for the sake of simplicity which are however known to those skilled in the art. Similarly, also interconnections and interfaces between the respective elements are shown only in a simplified manner.

Reference sign 10 designates a user equipment or subscriber station/mobile station (SS/MS) of a user. Reference 20 denotes an ASN GW (Access Service Network Gateway). The ASN GW 20 may be part of an access service network providing radio access to a WiMAX subscriber. In particular, via the ASN (Access Service Network), connections to servers and other networks/the Internet may be established, and AAA signaling to and from the user equipment 10 is exchanged. The connection between the user equipment 10 and the ASN GW is provided, for example, by an interface (I/F) for access to the network via a base station (BS) communicating with the user equipment.

Reference sign 30 denotes an AAA server executing authentication, authorization and accounting procedures for the user equipment 10 (the subscriber). For authentication procedures, the AAA server may use EAP based mechanisms for which an I/F to/from the ASN GW 20 is provided for processing a network access attempt of the user equipment 10.

Reference sign 40 denotes a device or server providing a captive (web) portal. The captive portal 40 may be used in connection with a restricted network access in examples of embodiments of the invention. According to WiMAX NWG standards, a capability referred to as “hotlining” is supported whereby an access of subscriber seeking access to the network can be restricted and/or redirected to a specific address, i.e. in the depicted network structure according to FIG. 1 to the web portal 40. Usually, hotlining is used e.g. for the purpose of prepaid account top-up. According to examples of embodiments of the invention, hotlining to the captive portal 40 is used for authentication purposes, as described below in greater detail. The interface between the captive portal 40 and the AAA server 30 for authentication procedure is, for example, RADIUS based. Then, for example, the captive portal may be provided by an http server running a module for authenticating users against information stored in a RADIUS server. Furthermore, according to the example presented in FIG. 1, the ASN GW 20 is capable of sending and receiving IP packets to/from the web portal 40 over a “hotlined” user plane path.

It is to be noted that the ASN GW 20 is connectable to other networks or the Internet by a “normal” user plane path, i.e. which is not hotlined (restricted to a specific destination).

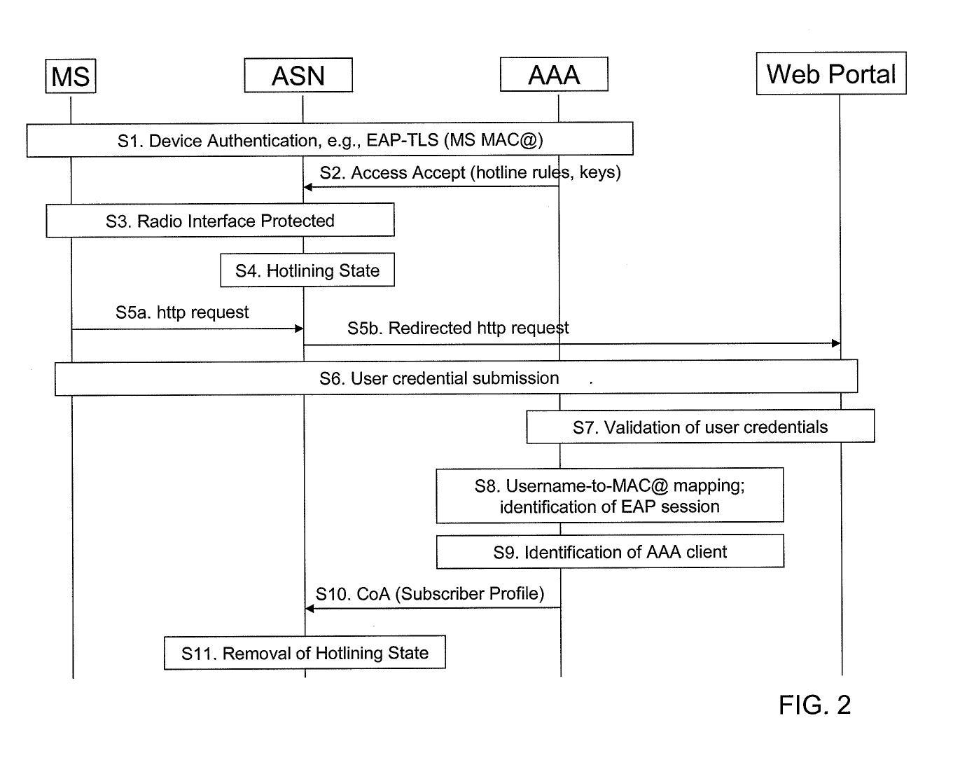

In the following, with reference to FIGS. 2 to 5, examples of an authentication and authorization mechanism are described wherein details thereof are also further explained with reference to the elements described in FIG. 1.

In FIG. 2, a first example of an authentication and authorization procedure according to an embodiment of the invention is described.

In the first example according to FIG. 2, it is assumed that the end-user's device includes a device certificate, such as a X.509 device certificate, which is pre-installed, for example, by the device manufacturer. It is to be noted that the device certificate may be a pre-requisite for device authentication required by several network types. Furthermore, as another pre-condition, it is assumed that the end-user may obtain a username and/or password for connection, i.e. some sort of personal identification as end-user credentials, through some out-of-band mechanism (e.g. at a point of sale, or by mail). Moreover, it is assumed that an authentication and authorization network element has access to specific data, e.g. the AAA server 30 may store a subscriber profile associated with the end-user credentials provided, for example, by the out-of-band mechanism. This subscriber profile includes a unique device identification, such as a permanent identifier of the user equipment like the end-user's device MAC address (MAC@), which the subscriber may use for access to the network, such as the WiMAX access.

According to FIG. 2, in step S1, an initial network access is executed between the user equipment MS and the AAA server via the ASN GW (and other network elements not shown for the sake of simplicity). For example, when the user powers up the device, the user equipment MS may perform a WiMAX access authentication procedure, such as a device authentication (e.g. using EAP-TLS) according to standardized procedures of WiMAX. In this initial network access, also a unique identification of the user equipment, like a permanent identifier of the user equipment such as the MAC address, is received by the AAA server. Furthermore, in the initial network access, for example, the user equipment and the network (the AAA system) may generate session keys for the duration of the network attachment (authentication session). Examples of such keys, are a master session key (MSK) or extended master session key (EMSK). Such keys are used for securing wireless access (for example, with the MSK key for WLAN or WiMAX access), or other applications like Mobile Internet Protocol (IP) or device provisioning with the EMSK key.

In step S2, assuming that the device certificate is valid, the AAA server successfully authenticates the user equipment MS and sends an Access-Accept message to the WiMAX access service network. In this message of step S2, keying material and an indication of restricted access to a web portal (the captive portal 40) is included, i.e. the access is indicated to be restricted to a “hotlining” access following predetermined hotline rules. The address of the captive (web) portal to be used for the restricted “hotline” access may be either indicated directly in the Accept-Access message in step S2, or an indicator may be provided which is related to a pre-stored list of address candidates for a captive portal. Furthermore, the AAA server stores an address or identifier of an AAA client, which may be part of the ASN, wherein a binding between the MAC address (the unique address) of the user equipment and the AAA client identifier may be performed.

In step S3, the radio link between the user equipment MS and the ASN is cryptographically protected, e.g. on the basis of the keying material indicated by the AAA server. As the ASN has learned by the message of the AAA server that the subscriber (the user equipment MS) is to be handled in the “hotlined” state (i.e. with restricted access to the web portal or captive portal 40, for example), the ASN prepares in step S4 to redirect specific traffic, such as IP based requests (http traffic), to this destination. Other traffic may be dropped. It is to be noted that there may be also other variations for traffic handling, depending of preset access rules. Furthermore, it is to be noted that steps S3 and S4 may be executed also in the reverse order (i.e. first step S4 and then step S3 are executed)

In step S5a, the user launches a web browser. Therefore, a corresponding request (http request) is sent through the ASN in step S5a. Due to the measures in step 4, a http request (step S5a) is redirected in step S5b to the captive portal. This can be done either automatically by instructing the http client or instructing the user in manual redirection technique.

Then, in step S6, a user credential submission procedure is executed between the user equipment MS and the captive portal. For example, the captive portal provides a login page prompting for an input of the subscriber credentials which have been received via the out-of-band mechanism indicated above. The subscriber inputs the credentials (user identification) to the captive portal by writing them, for example, in respective fields of the login page, and transmits the information to the captive portal.

When the information (user identification or credentials) are received by the captive portal, the identification is validated in step S7 by communicating the credentials to the AAA server, e.g. via a RADIUS based AAA interface. The AAA server used for validating the user identification is the same AAA server as that executing the initial network access in steps S1 and S2.

If the validation of the user credentials in step S7 is successful, i.e. when the web authentication of the user is successful, the AAA server processes in step S8 the identification information (i.e. the device identification received in step S1 and the user identification received in step S7). According to the present example, since the AAA server has also stored therein the subscriber profile indicated above, the user identification, such as a username or the like input in the user credential submission procedure of step S6 and obtained by the captive portal in step S7, is mapped to the unique device identification, such as the end-user's device MAC address, listed in the subscriber profile. By means of this <user name>-to-<MAC address> mapping, the AAA server is able to identify the EAP session over which the corresponding MAC address has been authenticated (step S1) since the corresponding MAC address has also been stored (as a first identification element).

Then, in step S9, the AAA server identifies the AAA client corresponding to the EAP session identified in step S8. This is done by using the identifier or address of the AAA client which is maintained in connection with step S2, i.e. with the help of the state maintained in step S2. In other words, the AAA client can be identified by a binding of the unique (MAC) address and the client identifier in step S2.

Depending on the result of the web authentication in step S7, the AAA server is triggered to change the state of the authorization provided to the subscriber by the initial network access mode, i.e. the restricted access.

For example, in case the web authentication in step S7 is successful, the AAA server sends a Change of Authorization message to the AAA client (in the ASN) identified in step S9. This Change of Authorization message may comprise also elements related to the subscriber profile stored in the AAA server, such as specific service authorization information, granted bandwidth and the like. Otherwise, in case the web authentication was not successful (e.g. the password is wrong), the network access may be denied, which involves a corresponding Change of Authorization message (e.g. for rejecting the connection).

Assuming that the web authentication was successful in step S7, the Change of Authorization message in step S10 may lift the initial (i.e. anonymous) access restriction rules (hotlined state) and indicates the subscriber specific access profile.

Thus, in step S11, the ASN cancels the restrictions provided in step S2 (the hotlining state) so that the user equipment MS is able to access to services as prescribed in the subscriber profile, for example, access to all IP services (as defined in his/her profile) is granted.

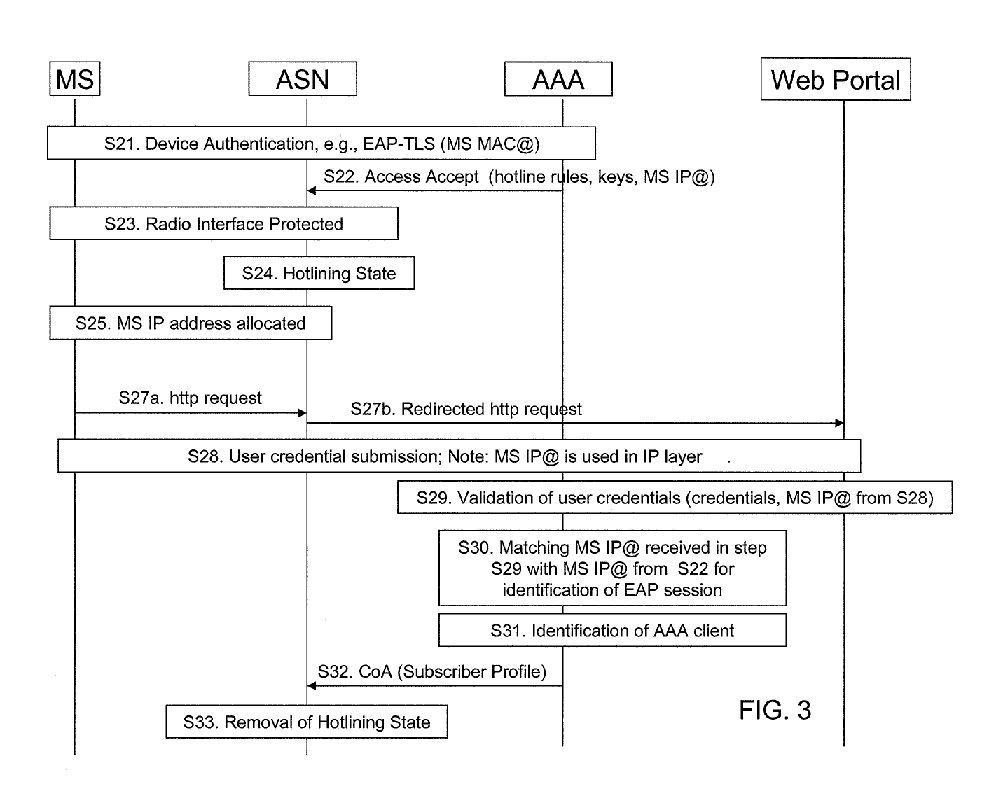

In FIG. 3, a second example of an authentication and authorization procedure according to an embodiment of the invention is described.

In the second example according to FIG. 3, similar to the first example according to FIG. 2, it is assumed that the end-user's device includes a device certificate, such as a X.509 device certificate, which is pre-installed, for example, by the device manufacturer. Furthermore, as another pre-condition, it is assumed that the end-user may obtain a username and/or password for connection, i.e. some sort of personal identification as end-user credentials, through an out-of-band mechanism (e.g. at a point of sale, or by mail).

However, different to the first example, in the second example according to FIG. 3, it is not necessary that the authentication and authorization network element (the AAA server) has access to a subscriber profile associated with the end-user's device MAC address. As will be described below, according to the second example, the captive portal forwards the other identification element, such as an IP address, to the AAA server.

According to FIG. 3, in step S21, an initial network access is executed between the user equipment MS and the AAA server via the ASN GW (and other network elements not shown for the sake of simplicity). For example, when the user powers up the device, the user equipment MS may perform a WiMAX access authentication procedure, such as a device authentication (e.g. using EAP-TLS) according to standardized procedures of WiMAX. In this initial network access, also a unique identification of the user equipment, like the MAC address, may be received by the AAA server. Furthermore, in the initial network access, for example, the user equipment and the network (the AAA system) may generate session keys for the duration of the network attachment (authentication session).

In step S22, assuming that the device certificate is valid, the AAA server successfully authenticates the user equipment MS and sends an Access-Accept message to the WiMAX access service network. In this message of step S22, keying material and an indication of restricted access to a web portal (the captive portal 40) is included, i.e. the access is indicated to be restricted to a “hotlining” access following predetermined hotline rules. The address of the captive (web) portal to be used for the restricted “hotline” access may be either indicated directly in the Accept-Access message in step S22, or an indicator may be provided which is related to a pre-stored list of address candidates for a captive portal. In addition, the AAA server allocates a settable address, such as an IP address (IP@), to the user equipment MS which is to be used for further communication. Furthermore, the AAA server stores an address or identifier of an AAA client, which may be part of the ASN, wherein a binding between the allocated IP address of the user equipment and the AAA client identifier may be performed.

In step S23, the radio link between the user equipment MS and the ASN is cryptographically protected, e.g. on the basis of the keying material indicated by the AAA server.

As the ASN has learned by the message of the AAA server that the subscriber (the user equipment MS) is to be handled in the “hotlined” state (i.e. with restricted access to the web portal or captive portal 40, for example), the ASN prepares in step S24 to redirect specific traffic, such as IP based requests (http traffic), to this destination. Other traffic may be dropped. It is to be noted that there may be also other variations for traffic handling, depending of preset access rules. Furthermore, it is to be noted that steps S23 and S24 may be executed also in the reverse order (i.e. first step S24 and then step S23 are executed)

In step S25, the user equipment MS configures its IP address with the ASN wherein the IP address is that received in step S22 from the AAA server.

In step S27a, the user launches a web browser. Therefore, a corresponding request (http request) is sent through the ASN in step S27a. Due to the measures in step 24, a http request (step S27a) is redirected in step S27b to the captive portal. This can be done either automatically by instructing the http client or instructing the user in manual redirection technique.

Then, in step S28, a user credential submission procedure is executed between the user equipment MS and the captive portal. For example, the captive portal provides a login page prompting for an input of the subscriber credentials which have been received via the out-of-band mechanism indicated above. The subscriber inputs the credentials (user identification) to the captive portal by writing them, for example, in respective fields of the login page, and transmits the information to the captive portal. Furthermore, a settable address such as the IP address of the user equipment MS used in the IP based session between the user equipment MS and the captive portal for the user credential submission is stored by the captive portal in connection with the credential information provided by the MS. It is to be noted that the IP address of the MS is that of step S25.

When the information (user identification or credentials) are received by the captive portal, the identification is validated in step S29 by communicating the credentials to the AAA server, e.g. via a RADIUS based AAA interface. In this connection, also the stored IP address information retrieved in step S28 are transmitted to the AAA server. The AAA server used for validating the user identification is the same AAA server as that executing the initial network access in steps S21 and S22.

If the validation of the user credentials in step S29 is successful, i.e. when the web authentication of the user is successful, the AAA server processes in step S30 the identification information (i.e. the identification element in the form of the IP address allocated in step S22 and the user identification in the form of the IP address received in step S29). According to the present example, it is determined whether there is a match between the IP address of step S22 and that of step S29. By means of this settable address matching process, the AAA server is able to identify the EAP session over which the corresponding MS IP is allocated in the initial authentication session (step S22) since the corresponding MS IP address has also been stored (as a first identification element).

Then, in step S31, the AAA server identifies the AAA client corresponding to the EAP session identified in step S30. This is done by using the identifier or address of the AAA client which is maintained in connection with step S22, i.e. with the help of the state maintained in step S22. In other words, the AAA client can be identified by a binding of the allocated settable (IP) address and the client identifier in step S22.

Depending on the result of the web authentication in step S29, the AAA server is triggered to change the state of the authorization provided to the subscriber by the initial network access mode, i.e. the restricted access.

For example, in case the web authentication in step S29 is successful, the AAA server sends in step S32 a Change of Authorization message to the AAA client (in the ASN) identified in step S31. This Change of Authorization message may comprise also elements related to the subscriber profile stored in the AAA server, such as specific service authorization information, granted bandwidth and the like. Otherwise, in case the web authentication was not successful (e.g. the password is wrong), the network access may be denied, which involves a corresponding Change of Authorization message (e.g. for rejecting the connection).

Assuming that the web authentication was successful in step S29, the Change of Authorization message in step S32 may lift the initial (i.e. anonymous) access restriction rules (hotlined state) and indicates the subscriber specific access profile.

Thus, in step S33, the ASN cancels the restrictions provided in step S22 (the hotlining state) so that the user equipment MS is able to access services as prescribed in the subscriber profile, for example, access to all IP services (as defined in his/her profile) is granted.

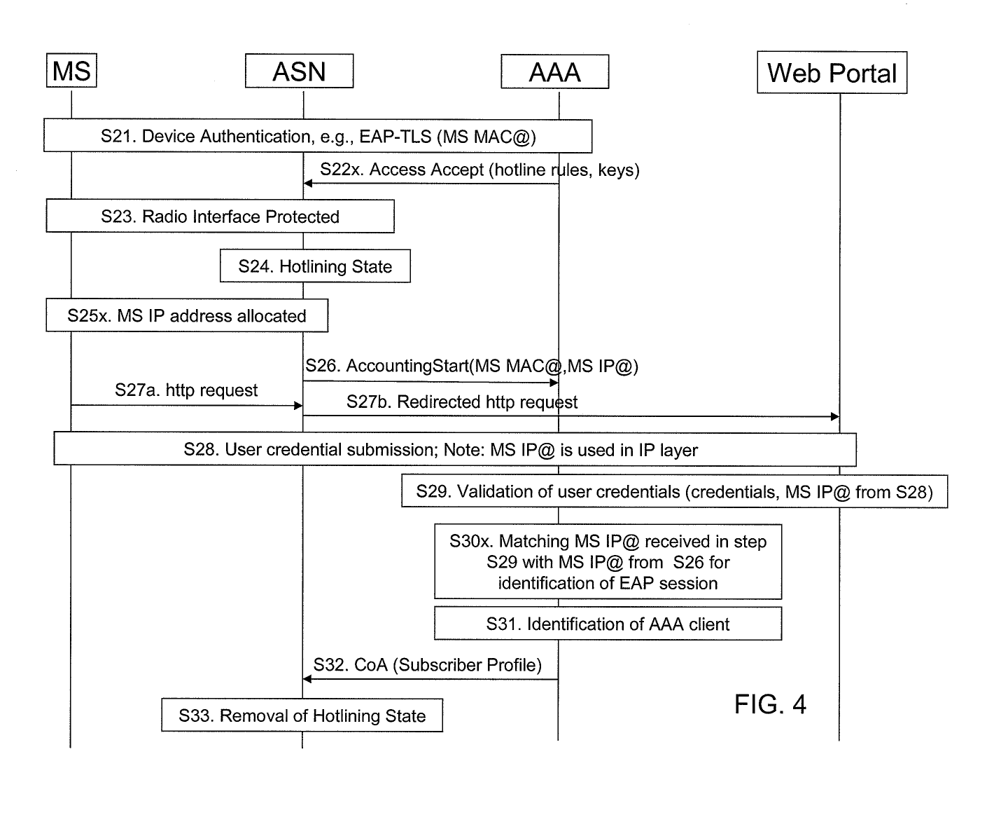

In FIG. 4, a third example of an authentication and authorization procedure according to an embodiment of the invention is described.

The third example according to FIG. 4 is similar to the second example according to FIG. 3. Thus, equivalent steps executed in both procedures are denoted with the same reference signs, and a detailed description of these equivalent steps is omitted for the sake of simplicity. Thus, in the following, in particular the differences between the second and third examples are explained.

Like in the second example, in the third example of FIG. 4, similar to the first example according to FIG. 2, it is assumed that the end-user's device includes a device certificate, such as a X.509 device certificate, which is pre-installed, for example, by the device manufacturer. Furthermore, as another pre-condition, it is assumed that the end-user may obtain a username and/or password for connection, i.e. some sort of personal identification as end-user credentials, through an out-of-band mechanism (e.g. at a point of sale, or by mail). Also, different to the first example, in the third example according to FIG. 4, it is not necessary that the authentication and authorization network element (the AAA server) has access to a subscriber profile associated with the end-user's device MAC address. As will be described below, according to the second example, the captive portal forwards the other identification element, such as an IP address, to the AAA server.

According to FIG. 4, after step S21, i.e. the initial network access procedure, in step S22x, when it is assumed that the device certificate is valid, the AAA server successfully authenticates the user equipment MS and sends an Access-Accept message to the WiMAX access service network. In this message of step S22x, keying material and an indication of restricted access to a web portal (the captive portal 40) is included, i.e. the access is indicated to be restricted to a “hotlining” access following predetermined hotline rules. The address of the captive (web) portal to be used for the restricted “hotline” access may be either indicated directly in the Accept-Access message in step S22x, or an indicator may be provided which is related to a pre-stored list of address candidates for a captive portal. Furthermore, the AAA server stores an address or identifier of an AAA client, which may be part of the ASN, wherein a binding between the MAC address (the unique address) of the user equipment and the AAA client identifier may be performed. However, different to the second example, the AAA server does not allocate a settable address, such as an IP address (IP@), to the user equipment MS.

Step S23 and S24 of the third example are equivalent to that of FIG. 3. In step S25x, the user equipment MS configures an IP address with the ASN wherein the IP address may be allocated, for example, by the ASN.

In step S26, the ASN uses a signaling to the AAA server for informing it about the settable address, i.e. the IP address of the MS, allocated in step S25x. For this purpose, for example, an Accounting Start message may be sent to the AAA server in which a mapping between the settable address (the allocated MS IP address) and the unique address of the user equipment (permanent identifier of the user equipment like the MS MAC address) is indicated. It is to be noted that the Accounting Start procedure is usually used for accounting purposes, but it may be used here for signaling the <IP address> to <MAC address> mapping. Thus, the AAA server has a link between the MAC address and the IP address used by the user equipment.

Step S27a, S27b, S28 and S29 are again equivalent to FIG. 3, wherein the IP address used in steps S27a and S27b is now the IP address of the MS of step S25x.

If the validation of the user credentials in step S29 is successful, i.e. when the web authentication of the user is successful, the AAA server processes in step S30x the identification information (i.e. the identification element in the form of the IP address received in step S26 and the user identification in the form of the IP address received in step S29). According to the present example, it is determined whether there is a match between the IP address of step S26 and that of step S29. Then, by the mapping of the MS IP address to the MS MAC address in step S26, the MAC address information of the user equipment can be obtained. By means of the address matching process, the AAA server is able to identify the EAP session over which the corresponding MAC address has been authenticated (step S21) since the corresponding MAC address has also been stored (as a first identification element).

Then, in step S31, the AAA server identifies the AAA client corresponding to the EAP session identified in step S30x. This is done by using the identifier or address of the AAA client which is maintained in connection with step S22x, i.e. with the help of the state maintained in step S22x. In other words, the AAA client can be identified by a binding of the unique address and the client identifier in step S22x.

Depending on the result of the web authentication in step S29, the AAA server is triggered to change the state of the authorization provided to the subscriber by the initial network access mode, i.e. the restricted access. The following steps S32 and S33 are equivalent to that of FIG. 3.

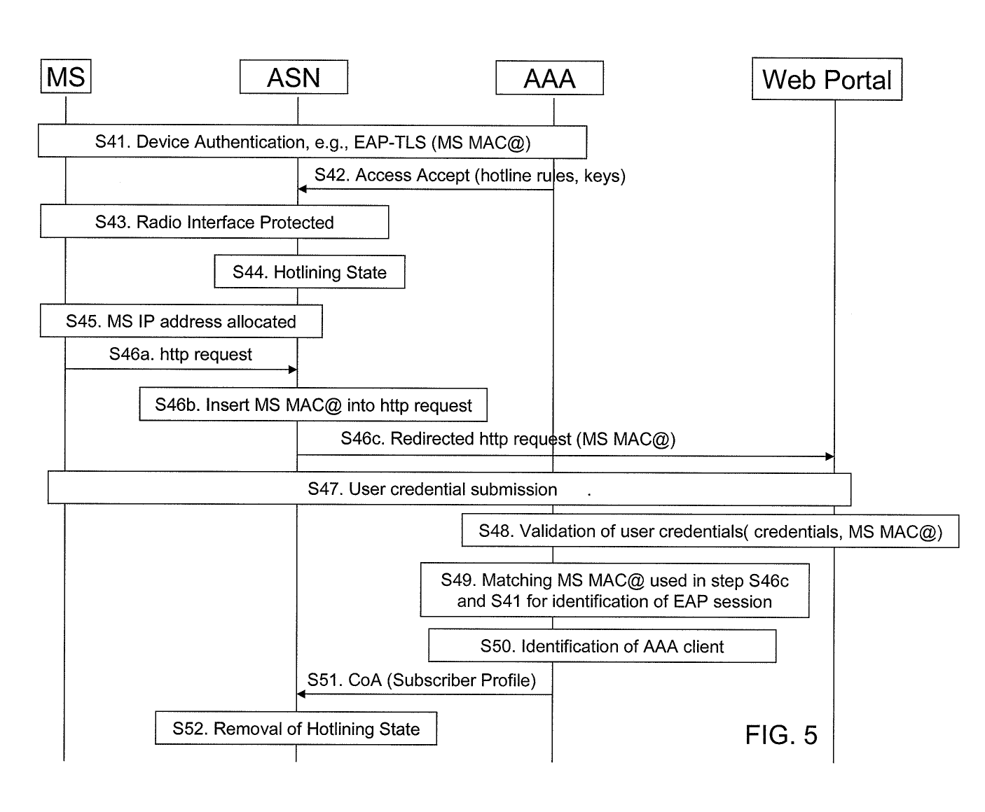

In FIG. 5, a fourth example of an authentication and authorization procedure according to an embodiment of the invention is described.

In the fourth example according to FIG. 5, similar to the first example according to FIG. 2, it is assumed that the end-user's device includes a device certificate, such as a X.509 device certificate, which is pre-installed, for example, by the device manufacturer. Furthermore, as another pre-condition, it is assumed that the end-user may obtain a username and/or password for connection, i.e. some sort of personal identification as end-user credentials, through an out-of-band mechanism (e.g. at a point of sale, or by mail).

However, different to the first example, in the fourth example according to FIG. 5, it is not necessary that the authentication and authorization network element (the AAA server) has access to a subscriber profile associated with the end-user's device MAC address. As will be described below, according to the second example, the captive portal forwards an identification element, such as a unique device identification element as permanent identifier of the user equipment, like a MAC address, to the AAA server which was received from the ASN beforehand.

According to FIG. 5, in step S41, an initial network access is executed between the user equipment MS and the AAA server via the ASN GW (and other network elements not shown for the sake of simplicity). For example, when the user powers up the device, the user equipment MS may perform a WiMAX access authentication procedure, such as a device authentication (e.g. using EAP-TLS) according to standardized procedures of WiMAX. In this initial network access, also a unique identification of the user equipment, like a permanent identifier of the user equipment such as the MAC address, is received by the AAA server. Furthermore, in the initial network access, for example, the user equipment and the network (the AAA system) may generate session keys for the duration of the network attachment (authentication session).

In step S42, assuming that the device certificate is valid, the AAA server successfully authenticates the user equipment MS and sends an Access-Accept message to the WiMAX access service network. In this message of step S42, keying material and an indication of restricted access to a web portal (the captive portal 40) is included, i.e. the access is indicated to be restricted to a “hotlining” access following predetermined hotline rules. The address of the captive (web) portal to be used for the restricted “hotline” access may be either indicated directly in the Accept-Access message in step S42, or an indicator may be provided which is related to a pre-stored list of address candidates for a captive portal. Furthermore, the AAA server stores an address or identifier of an AAA client, which may be part of the ASN, wherein a binding between the received unique address (MAC address) of the user equipment and the AAA client identifier may be performed.

In step S43, the radio link between the user equipment MS and the ASN is cryptographically protected, e.g. on the basis of the keying material indicated by the AAA server.

As the ASN has learned by the message of the AAA server that the subscriber (the user equipment MS) is to be handled in the “hotlined” state (i.e. with restricted access to the web portal or captive portal 40, for example), the ASN prepares in step S44 to redirect specific traffic, such as IP based requests (http traffic), to this destination. Other traffic may be dropped. It is to be noted that there may be also other variations for traffic handling, depending of preset access rules. Furthermore, it is to be noted that steps S43 and S44 may be executed also in the reverse order (i.e. first step S44 and then step S43 are executed)

In step S45, the user equipment MS configures its IP address with the ASN wherein the IP address may be allocated, for example, by the ASN.

In step S46a, the user launches a web browser. Therefore, a corresponding request (http request) is sent through the ASN in step S46a.

After receiving the request in step S46a, the ASN (like the ASN GW 20) processes the request in S46b and recognizes by the settings of step S44 the hotline state for this message. Therefore, it includes in S46b an identification element into the message, for example in the form of a unique address (MAC address) of the user equipment MS. Thus, the http request (step S46a) is redirected in step S46c together with an indication of the MS MAC address to the captive portal. This can be done either automatically by instructing the http client or instructing the user in manual redirection technique.

Then, in step S47, a user credential submission procedure is executed between the user equipment MS and the captive portal. For example, the captive portal provides a login page prompting for an input of the subscriber credentials which have been received via the out-of-band mechanism indicated above. The subscriber inputs the credentials (user identification) to the captive portal by writing them, for example, in respective fields of the login page, and transmits the information to the captive portal. The credential information provided by the MS are stored by the captive portal, wherein it is to be noted that also the MS MAC address received in the initial message for the validation procedure (i.e. the message in S46c) is stored.

When the information (user identification or credentials) are received by the captive portal, the identification is validated in step S48 by communicating the credentials to the AAA server, e.g. via a RADIUS based AAA interface. In this connection, also the stored unique address information (MAC address) retrieved in step S46c are transmitted to the AAA server. The AAA server used for validating the user identification is the same AAA server as that executing the initial network access in steps S41 and S42.

If the validation of the user credentials in step S48 is successful, i.e. when the web authentication of the user is successful, the AAA server processes in step S49 the identification information (i.e. the identification element in the form of the MS MAC address received in step S41 and the user identification in the form of the MS MAC address transmitted in step S46c and obtained by step S48). According to the present example, it is determined whether there is a match between the MAC address of step S42 and that of step S48. By means of this unique address matching process, the AAA server is able to identify the EAP session over which the corresponding MS MAC address is received in the initial authentication session (step S41) since the corresponding MS MAC address has also been stored (as a first identification element).

Then, in step S50, the AAA server identifies the AAA client corresponding to the EAP session identified in step S49. This is done by using the identifier or address of the AAA client which is maintained in connection with step S42, i.e. with the help of the state maintained in step S42. In other words, the AAA client can be identified by a binding of the unique (MAC) address and the client identifier in step S42.

Depending on the result of the web authentication in step S48, the AAA server is triggered to change the state of the authorization provided to the subscriber by the initial network access mode, i.e. the restricted access.

For example, in case the web authentication in step S48 is successful, the AAA server sends a Change of Authorization message to the AAA client (in the ASN) identified in step S50. This Change of Authorization message may comprise also elements related to the subscriber profile stored in the AAA server, such as specific service authorization information, granted bandwidth and the like. Otherwise, in case the web authentication was not successful (e.g. the password is wrong), the network access may be denied, which involves a corresponding Change of Authorization message (e.g. for rejecting the connection).

Assuming that the web authentication was successful in step S48, the Change of Authorization message in step S51 may lift the initial (i.e. anonymous) access restriction rules (hotlined state) and indicates the subscriber specific access profile.

Thus, in step S52, the ASN cancels the restrictions provided in step S42 (the hotlining state) so that the user equipment MS is able to access to services as prescribed in the subscriber profile, for example, access to all IP services (as defined in his/her profile) is granted.

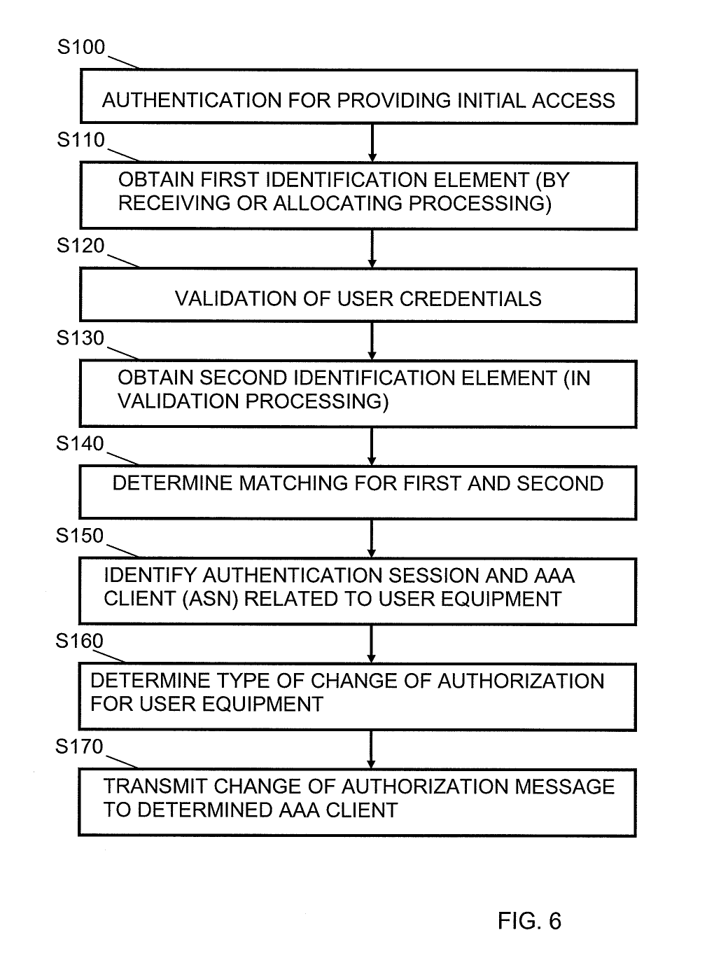

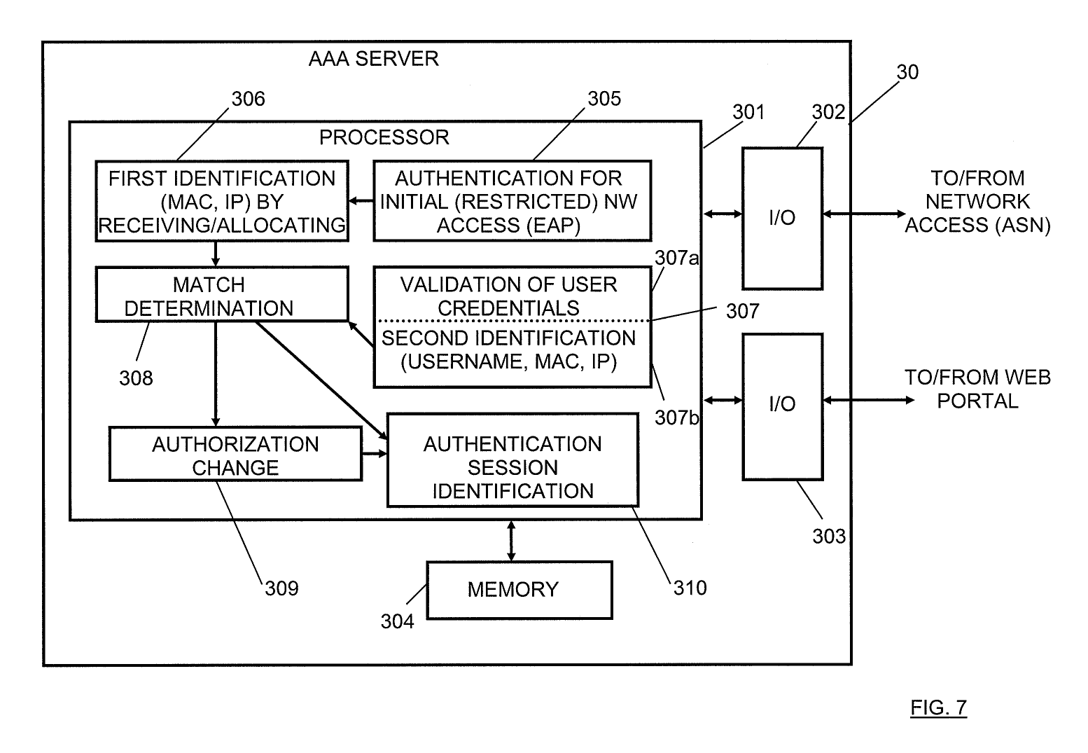

Next, with reference to FIGS. 6 and 7, a further example of an embodiment of the invention is described. The present example is directed to the general processing of an authentication and authorization element involved in a authentication and authorization processing, such as an AAA server 30 according to FIG. 1.

In FIG. 6, a flow chart of a processing in the authentication and authorization procedure is shown.

In step S100, an initial authentication session for a user equipment 10 is executed in accordance with an authentication, authorization and accounting procedure for providing an initial network access. When implemented in a network structure as shown in FIG. 1, the authentication session in step S100 is used for getting a WiMAX access authentication, for example.

In connection with this initial authentication session, a first identification element related to the user equipment is obtained in step S110. For example, the first identification element may be a unique device identification, such as a permanent identifier of the user equipment like a MAC address of the user equipment, or an address which is allocated by a network element, like an IP address for the user equipment. In the latter case, this IP address may be allocated by the AAA server or by another network element, like an ASN element.

In step S120, a user credential validation procedure is executed. For example, a captive (web) portal used for user credential submission initiates the user credential validation by request and provides data corresponding to the submitted user credentials. In connection with the user credential validation procedure of step S120, in step S130, a second identification element is retrieved. This second identification element may be related either to the user (e.g. in form of an indication of a username or the like) or to an address of the user equipment (unique (MAC) address or settable (IP) address) which the web portal receives during the submission of the user credentials and forwards for the validation processing.

Then, a further processing of the obtained first and second identification elements is executed. In this processing, in step S140, it is determined whether a matching between the first and second identification elements exists. This determination may be based, for example, on a direct comparison between the first and second identification elements in case both identification elements are of a corresponding type (two MAC/IP addresses), or it may be based on a mapping procedure in case the first and second identification elements are of different types (username and MAC address, or the like). As a further step of the processing, in step S150, it is then identified (provided that the matching determination is successful) to which authentication session the identification elements are related. In other words, it is determined which initial authentication session executed for the user equipment belongs to the user equipment related to the user credential validation procedure, on the basis of the result of the processing of the first and second identification elements.

Also in step S150, an AAA client involved in the initial authentication session is identified. This may be done, for example, by using a binding between a stored identifier of the AAA client with the first identification element obtained beforehand in connection with the initial authentication session. The link to the second identification element, which is obtained in connection with the validation procedure of steps S120, S130 is provided by the processing steps S140, S150.

Then, in step S160, it is determined which type of authorization change is to be effected for the user equipment, in accordance with the results of the validation procedure, for example. In case the validation procedure results in a successful authorization, settings for the network access of the user equipment according to authorization indications in a subscriber profile can be set for granting access to services/networks. Otherwise, in case the validation procedure does not result in a successful authorization, the connection may be rejected, maintained in a restricted state, or the like.

In step S170, a change of authorization message indicating the type of authorization change determined in step S160 is transmitted to the determined AAA client which may then put the respective settings into force.

In FIG. 7, a block circuit diagram of an AAA server is shown which illustrates those parts of the AAA server 30 of FIG. 1 which are used for implementing the method described in connection with FIG. 6.

It is to be noted that only those parts of the AAA server 30 are depicted in FIG. 7 which are involved in the authentication/authorization mechanism according to an example of an embodiment of the invention. It is to be noted that the AAA server 30 may comprise several further elements or functions besides those described in connection with FIG. 7 which are omitted herein for the sake of simplicity as they are not essential for understanding the invention.

In detail, the AAA server 30 comprises a processor 301 as the main control unit, input/output units (I/O) 302, 303 connected to the processor 301 for establishing a connection with the access network subsystem (e.g. the WiMAX ASN GW of FIG. 1) or with an element or server providing the captive (web) portal, and a memory 304 connected to the processor 301 for storing data and programs executed by the processor 301.

In the processor 301, a processor portion 305 (authentication processor) for executing the initial authentication procedure, e.g. via EAP based communication, with the user equipment (via the ASN) is provided (according to steps S1, S2, S21, S22, S41, S42, and S100, for example). The processor portion 305 may provide the initial (restricted) network access including the indication of the hotlining state. Furthermore, linked to the authentication processor 305, a (first) processor portion 306 configured to obtain a first identification element related to the user equipment is provided. The processor portion 306 may obtain the first identification element in the form of a MAC address or an IP address which in turn may be allocated by the processor portion 306 or received in a further communication, for example, from the ASN.

A validation processor portion 307 comprising parts 307a and 307b is also provided in the processor 301. The processor portion 307a is configured to perform a user credential validation procedure by communicating with the web portal 40, for example. The processor portion 307b (second processor portion) is configured to obtain, in the user credential validation procedure, a second identification element related to the user equipment or related to a user of the user equipment. In other words, the processor portion 307b may obtain the second identification element in the form of a username, an unique (MAC) address of the user equipment provided by the web portal, or a settable (IP) address of the user equipment provided by the web portal.

In a processor portion 308 (information processor), the first and second identification elements from the processor portions 306 and 307b, respectively, are processed so as to determine whether a match between the first and second identification elements exists. The processing of the processor portion 308 may correspond to step S140 of FIG. 6, for example.

In a processor portion 309, the authorization change is determined as a result of the processing of the information processor. For example, settings according to a subscriber portal may be learned in case the authentication of the user equipment is successful.

In a processor portion 310 (third processor portion), the authentication session executed for the user equipment is identified. This is done, for example, on the basis of the result of the information processor 308 processing the first and second identification elements. The processor portion 310 may also be configured to identify the AAA client which is involved in the authorization session for forwarding authorization change signaling to it.

The authorization change processor portion 309 may initiate also the change of the authorization of the user equipment for providing a modified network access by initiating the transmission of the determined authorization settings to the AAA client.

It is to be noted that the structure of the authentication and authorization element (the AAA servers) described in connection with FIG. 7 is also applicable in examples of the authentication and authorization procedures described in FIGS. 2 to 5.

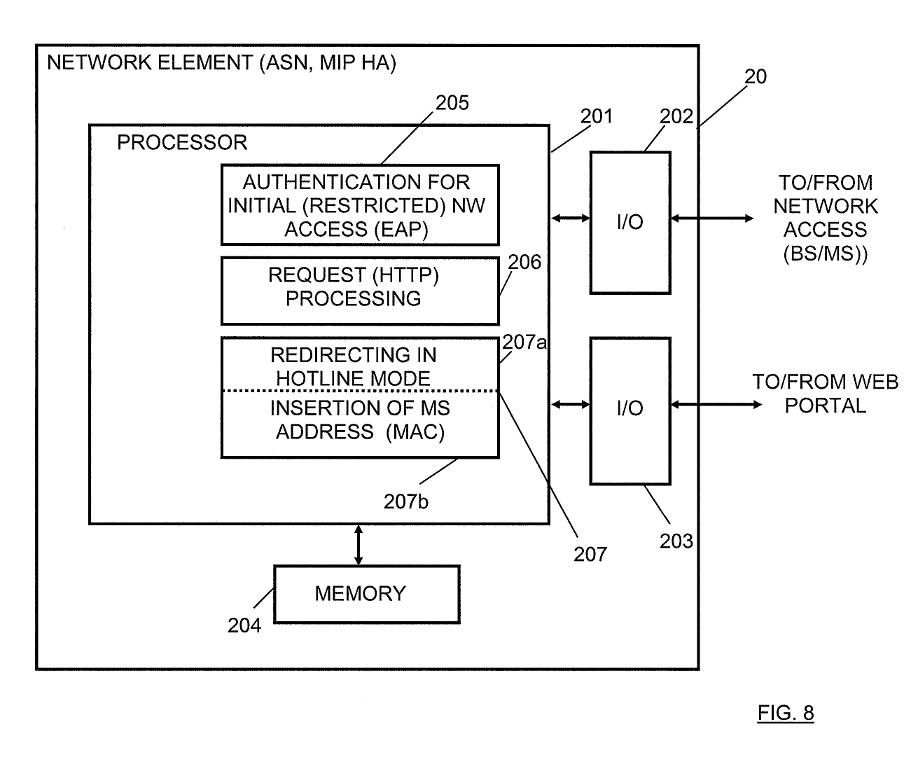

With regard to FIG. 8, a further example of an embodiment of the invention is described. FIG. 8 depicts an apparatus structure of a network element which may be placed at the access service network side, for example in the ASN GW according to FIG. 1, wherein an authentication and authorization procedure according to an example corresponding to that described in connection with FIG. 5 (the fourth example) is executed.

As indicated in connection with the authentication and authorization procedure according to the fourth example, the ASN provides to the captive portal an indication of an identification element in the form of the unique (MAC) address of the user equipment MS (see steps S46b, S46c in FIG. 5). This identification element is then used by the AAA server for the processing of the first and second identification elements as the second identification element.

For this purpose, in the block circuit diagram of an apparatus according to FIG. 8, which may be used in the ASN element, those parts of the network element (e.g. the ASN GW 20 of FIG. 1) are illustrated which are used for implementing this measures in the authentication and authorization procedure according to an example corresponding to FIG. 5, for example. It is to be noted that only those parts of the network element 20 are depicted in FIG. 8 which are involved in the authentication/authorization mechanism according to this example of an embodiment of the invention. The network element 20 may comprise several further elements or functions besides those described in connection with FIG. 8 which are omitted herein for the sake of simplicity as they are not essential for these measures.

In detail, the apparatus being part of the network element 20 comprises a processor 201 as the main control unit, input/output units (I/O) 202, 203 connected to the processor 201 for establishing a connection with the network access (e.g. a base station BS and the MS via the WiMAX access) or with an element or server providing the captive (web) portal, and a memory 204 connected to the processor 201 for storing data and programs executed by the processor 201.

In the processor 201, a processor portion 205 as an authentication processor is provided which is used for the execution of an authentication session in an authentication, authorization and accounting procedure for the user equipment for providing an initial network access.

A processor portion 206 determines that a request message from the user equipment is to be processed in the hotlined state, i.e. that it is to be re-directed to the captive portal. If this is determined, then in a processor portion 207 comprising parts 207a and 207b a corresponding processing is effected. This means that in the processing portion 207a the destination for the re-directing is determined (based on information received in the initial authentication processing, for example, from the processor portion 205). Furthermore, in the processor portion 207b, the message to be forwarded to the captive portal (in the hotlined mode) is added by an indication of a unique address (MAC address) of the user equipment. Hence, the processor portion 207b adds an identification element of the user equipment.

Even though in the preceding description of the examples of embodiments of the invention the ASN GW 20 is described as being the network element, it is to be noted that as an alternative the hotlining processing, i.e. the re-directing to the captive portal of specific requests (http requests) from the user equipment, and access gating processing can be alternatively or additionally executed by an Mobile IP Home Agent.

For the purpose of the present invention as described herein above, it should be noted that
an access technology via which signaling is transferred to and from a UE may be any technology by means of which a user equipment can access an access network (e.g. via a base station or generally an access node). Any present or future technology, such as WLAN (Wireless Local Access Network), WiMAX (Worldwide Interoperability for Microwave Access), BlueTooth, Infrared, and the like may be used; although the above technologies are mostly wireless access technologies, e.g. in different radio spectra, access technology in the sense of the present invention implies also wirebound technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable access networks may be any device, apparatus, unit or means by which a station, entity or other user equipment may connect to and/or utilize services offered by the access network; such services include, among others, data and/or (audio-) visual communication, data download etc.;
a user equipment may be any device, apparatus, unit or means by which a system user or subscriber may experience services from an access network, such as a mobile phone, personal digital assistant PDA, or computer provided with a corresponding communication module, and the like;
method steps likely to be implemented as software code portions and being run using a processor at a network element or terminal (as examples of devices, apparatuses and/or modules thereof, or as examples of entities including apparatuses and/or modules therefor), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device or apparatus may be regarded as an apparatus or as an assembly of more than one apparatus, whether functionally in cooperation with each other or functionally independently of each other but in a same device housing, for example.

As described above, there is proposed a network access authentication and authorization mechanism in which an authentication session in an authentication, authorization and accounting procedure for a user equipment for providing an initial network access is executed. A first identification element related to the user equipment is obtained. Then, a user credential validation procedure is performed wherein a second identification element related to the user equipment or related to a user of the user equipment is obtained. The obtained first and second identification elements are processed for determining whether a match between the first and second identification elements exists. In addition, the authentication session executed for the user equipment is identified on the basis of the result of the processing of the first and second identification elements. Then, a change of an authorization of the user equipment is executed for providing a modified network access.

Although the present invention has been described herein before with reference to particular embodiments thereof, the present invention is not limited thereto and various modifications can be made thereto.

1. Method comprising
executing an authentication session in an authentication, authorization and accounting procedure for a user equipment for providing an initial network access,
obtaining a first identification element related to the user equipment,
performing a user credential validation procedure,
obtaining, in the user credential validation procedure, a second identification element related to the user equipment or related to a user of the user equipment,
processing the first and second identification elements for determining whether a match between the first and second identification elements exists,
identifying the authentication session executed for the user equipment on the basis of the result of the processing of the first and second identification elements, and
initializing a change of an authorization of the user equipment for providing a modified network access.

2. The method according to claim 1, further comprising
transmitting, when the initial network access is accepted, rule information for a restricted network access as the initial network access, said rule information comprising an address indication of a captive portal accessible by the restricted network access.

3. The method according to claim 1, further comprising
storing an identifier of an authentication, authorization and accounting client serving the user equipment in the authentication session for providing the initial network access, said identifier being bound to the first identification element,
wherein the initializing of the change of the authorization further comprises
determining the authentication, authorization and accounting client serving the user equipment on the basis of the binding of the identifier to the first identification element by using the result of the processing of the first and second identification elements, and
transmitting an authorization change instructing message to the determined authentication, authorization and accounting client.

4. The method according to claim 1, wherein the obtaining of the first identification element comprises
receiving a unique address, in particular a media access control address, of the user equipment in the authentication session.

5. The method according to claim 1, wherein the obtaining of the first identification element comprises one of
allocating a settable address, in particular an Internet Protocol address, to the user equipment, and
receiving a settable address, in particular an Internet Protocol address, allocated to the user equipment from an access service network element communicating with the user equipment.

6. The method according to claim 4, wherein the obtaining of the second identification element comprises
receiving a username indication of the user equipment as the second identification element,
wherein the processing of the first and second identification elements for determining whether a match between the first and second identification elements exists comprises
mapping the username indication to a pre-stored subscriber profile list indicating a relation between a respective username and a corresponding unique address, in particular a media access control address, of a user equipment, and
comparing the unique address retrieved from the subscriber profile list and the received unique address for determining existence of the match between the first and second identification elements.

7. The method according to claim 4, wherein the obtaining of the second identification element comprises
receiving, in the user credential validation procedure, a unique address of the user equipment, in particular a media access control address, as the second identification element,
wherein the processing of the first and second identification elements for determining whether a match between the first and second identification elements exists comprises
comparing the unique address received in the user credential validation procedure and the unique address received in the authentication session for determining existence of the match between the first and second identification elements.

8. The method according to claim 5, wherein the obtaining of the second identification element comprises
receiving, in the user credential validation procedure, a settable address of the user equipment, in particular an Internet Protocol address, as the second identification element,
wherein the processing of the first and second identification elements for determining whether a match between the first and second identification elements exists comprises
comparing the settable address received in the user credential validation procedure and the settable address allocated to the user equipment as the first identification element for determining existence of the match between the first and second identification elements.

9. The method according to claim 1, wherein the method is executed by an authentication, authorization and accounting server in a WiMAX based communication network.

10. Apparatus comprising
an authentication processor configured to execute an authentication session in an authentication, authorization and accounting procedure for a user equipment for providing an initial network access,
a first processor portion configured to obtain a first identification element related to the user equipment,
an validation processor configured to perform a user credential validation procedure,
a second processor portion configured to obtain, in the user credential validation procedure, a second identification element related to the user equipment or related to a user of the user equipment,
an information processor configured to process the first and second identification elements for determining whether a match between the first and second identification elements exists,
a third processor portion configured to identify the authentication session executed for the user equipment on the basis of the result of the information processor processing of the first and second identification elements, and
an initiator configured to initialize a change of an authorization of the user equipment for providing a modified network access.

11. The apparatus according to claim 10, further comprising
a fourth processor portion configured to set and transmit, when the initial network access is accepted, rule information for a restricted network access as the initial network access, said rule information comprising an address indication of a captive portal accessible by the restricted network access.

12. The apparatus according claim 10, further comprising
a memory configured to store an identifier of an authentication, authorization and accounting client serving the user equipment in the authentication session for providing the initial network access, said identifier being bound to the first identification element,
wherein the initiator configured to initialize the change of the authorization is further configured to
determine, by the third processor portion, the authentication, authorization and accounting client serving the user equipment on the basis of the binding of the identifier to the first identification element by using the result of the processing of the first and second identification elements, and
to transmit an authorization change instructing message to the determined authentication, authorization and accounting client.

13. The apparatus according to claim 10, wherein the first processor portion configured to obtain the first identification element comprises
a receiver configured to receive a unique address, in particular a media access control address, of the user equipment in the authentication session.

14. The apparatus according to claim 10, wherein the first processor portion configured to obtain the first identification element comprises one of
an allocator configured to allocate a settable address, in particular an Internet Protocol address, to the user equipment, and
a receiver configured to receive a settable address, in particular an Internet Protocol address, allocated to the user equipment from an access service network element communicating with the user equipment.

15. The apparatus according to claim 13, wherein the second processor portion configured to obtain the second identification element comprises
a receiver configured to receive a username indication of the user equipment as the second identification element,
wherein the information processor configured to process the first and second identification elements for determining whether a match between the first and second identification elements exists comprises
a mapper configured to map the username indication to a pre-stored subscriber profile list indicating a relation between a respective username and a corresponding unique address, in particular a media access control address, of a user equipment, and
a comparator configured to compare the unique address retrieved from the subscriber profile list and the received unique address for determining existence of the match between the first and second identification elements.

16. The apparatus according to claim 13, wherein the second processor portion configured to obtain the second identification element comprises
a receiver configured to receive, in the user credential validation procedure, a unique address of the user equipment, in particular a media access control address, as the second identification element,
wherein the information processor configured to process the first and second identification elements for determining whether a match between the first and second identification elements exists comprises
a comparator configured to compare the unique address received in the user credential validation procedure and the unique address received in the authentication session for determining existence of the match between the first and second identification elements.

17. The apparatus according to claim 15, wherein the second processor portion configured to obtain the second identification element comprises
a receiver configured to receive, in the user credential validation procedure, a settable address of the user equipment, in particular an Internet Protocol address, as the second identification element,
wherein the information processor configured to process the first and second identification elements for determining whether a match between the first and second identification elements exists comprises
a comparator configured to compare the settable address received in the user credential validation procedure and the settable address allocated to the user equipment as the first identification element for determining existence of the match between the first and second identification elements.

18. The apparatus according to claim 10, wherein the apparatus is comprised in an authentication, authorization and accounting server in a WiMAX based communication network.

19. Method comprising
executing an authentication session in an authentication, authorization and accounting procedure for a user equipment for providing an initial network access,
re-directing a request message from the user equipment to a predetermined address of an captive portal, and
inserting a unique address, in particular a media access control address, of the user equipment into the redirected request message, said inserted unique address being provided as an identification element of the user equipment.

20. The method according to claim 19, wherein the method is executed by one of an access service network element comprising an authentication, authorization and accounting client and a mobile Internet Protocol home agent in a WiMAX based communication network.

21. Apparatus comprising
an authentication processor configured to execute an authentication session in an authentication, authorization and accounting procedure for a user equipment for providing an initial network access,
a forwarder configured to re-direct a request message from the user equipment to a predetermined address of an captive portal, and
an inserter configured to insert a unique address, in particular a media access control address, of the user equipment into the redirected request message, said inserted unique address being provided as an identification element of the user equipment.

22. The apparatus according to claim 21, wherein the apparatus is comprised in one of an access service network element comprising an authentication, authorization and accounting client and a mobile Internet Protocol home agent in a WiMAX based communication network.

23. A computer program product for a computer, comprising software code portions for performing the steps of claim 1 when said product is run on the computer.

24. A computer program product according to claim 23, wherein said computer program product comprises a computer-readable medium on which said software code portions are stored, and/or wherein said computer program product is directly loadable into the internal memory of the computer.

25. A computer program product for a computer, comprising software code portions for performing the steps of claim 19 when said product is run on the computer.
